(19) United States
(12) Patent Application Publication
(10) Pub. No.: US 2021/0329880 A1
(43) Pub. Date: Oct. 28, 2021

(54) COLLAPSIBLE PET CARRIER

(71) Applicant: Marcus Thomas, Beckley, WV (US)

(72) Inventor: Marcus Thomas, Beckley, WV (US)

(21) Appl. No.: 17/239,472

(22) Filed: Apr. 23, 2021

Related U.S. Application Data
(60) Provisional application No. 63/015,496, filed on Apr. 25, 2020.

(51) Int. Cl. A01K 1/02; A01K 1/00

(52) U.S. Cl. CPC A01K 1/0245; A01K 1/0064

(57) ABSTRACT

A rolled and collapsible pet carrier includes an elongated panel mutually coupled with a first upstanding sidewall and a second upstanding sidewall. The panel includes a floor forming the base or bottom of the pet carrier, wherein the first upstanding sidewall is mutually coupled with the floor and the second upstanding sidewall is mutually coupled with the floor. The panel is foldable along a plurality of seams to form a center portion that defines the enclosure of the carrier.

### I. RELATED APPLICATIONS

This application claims the benefit of U.S. Provisional Application No. 63/015,496, filed on Apr. 25, 2020.

### II. FIELD OF THE INVENTION

This application discloses claims and embodiments generally related to a pet carrier, and more particularly, a pet carrier with collapsible, rollable walls for compact storage and transport.

### III. BACKGROUND OF THE INVENTION

Numerous attempts have been made to improve transport of animals between different locations. Vehicles with dedicated and separated spaces have been utilized, especially haulers and/or trailers for moving livestock, farm animals, horses, and the like, have been utilized for decades to achieve transport. For smaller animals, including the many variety of pets that have become acceptable for home adoption and upkeep, a wide variety of four-walled crates, multi-walled and open-top pens, and the like have been developed for use both in the home and for transport in automobiles.

Despite these developments, the crates and pens suffer from several deficiencies. For example, the crates or pens are typically made from rigid metal formed into wire. Although the wire is often coated with paint or other protective material(s), the rigidity and defined edges and perimeter of the wire-based cage or pen often mars and/or damages other surfaces, including floors, walls, and inside of automobiles the leather, fabric, and/or plastic surfaces defining the interior walls, seats, and compartments formed within the automobile. Relatedly, the wire-based construction of so many cages/pens results in increased interior or compartment noise during travel, especially with the door and the latches moving along with the bumps and/or directional movement of the cage/pen within the automobile.

Moreover, despite many wire-based crates or pens having some collapsible characteristic(s), the crate/pen may only be reduced to the generally size of one of the walls of the crate/pen. And, despite the somewhat collapsible nature of the crate/pen, the wire-based rigidity still demands a high degree of care in moving and positioning of the cage/pen because of the marring and/or damage that can result without specific attention and care dedicated to the handling of the collapsed cage/pen.

Additionally, during use and in-route, a animal or animals temporarily housed within a cage or pen set-up inside of an automobile potentially subjects the animal(s) to abrupt stops and starts that can cause the animal(s) to inadvertently slam into the sidewalls of the cage or pen. Not only does such abrupt stopping and starting cause an increased level of stress on the animal(s), but such situations may accidently result in injury(ies) to the animal(s) when slamming into the relatively rigid sidewalls of the cage/pen.

Accordingly, there remains a need for improvements to the animal and/or pet carrier or transport devices presently available.

### IV. SUMMARY OF THE INVENTION

In one embodiment, a pet carrier comprises an elongated panel mutually coupled with a first upstanding sidewall and a second upstanding sidewall, the elongated panel comprising a floor, wherein the first upstanding sidewall is mutually coupled with the floor along a first lower side margin, and wherein the second upstanding sidewall is mutually coupled with the floor along a second lower side margin, the first lower side margin and second lower side margin in mutual opposition, and the first upstanding sidewall and the second upstanding sidewall in mutual opposition, and the elongated panel comprising a plurality of walls defining the center covering of the pet carrier, the elongated panel comprising at least the first end wall and the top wall.

In another embodiment, a storage bag, a pet carrier comprises an elongated panel mutually coupled with a first upstanding sidewall and a second upstanding sidewall, the elongated panel comprising a floor, wherein the first upstanding sidewall is mutually coupled with the floor along a first lower side margin, and wherein the second upstanding sidewall is mutually coupled with the floor along a second lower side margin, the first lower side margin and second lower side margin in mutual opposition, and the first upstanding sidewall and the second upstanding sidewall in mutual opposition, the elongated panel comprising a plurality of walls defining the center covering of the pet carrier, the elongated panel comprising at least the first end wall and the top wall, the elongated panel foldable and compressible and forming a rolled apparatus storable within the storage bag.

In one variation of the embodiments described above, wherein the panel comprises a proximal end adjacent the first upstanding sidewall and the second upstanding sidewall and an opposing distal end, wherein the proximal end including the floor and a first upstanding end wall depending from the floor, a top wall depending from the first upstanding end wall, and a second upstanding end wall depending from the top wall, with the second upstanding end wall defining the distal end of the panel, wherein the panel further comprises a plurality of seams formed along the panel, wherein a first panel seam is formed between the floor and the first upstanding end wall, a second panel seam is formed between the first upstanding end wall and the top wall, a third panel seam is formed between the top wall and the second upstanding end wall, and a fourth panel seam is formed at the juncture between the second upstanding end wall and the floor.

In another variation of the embodiments described above, the panel comprises a proximal end adjacent the first upstanding sidewall and the second upstanding sidewall and an opposing distal end, the panel comprising a second upstanding end wall at the proximal end comprising the floor, the first upstanding end wall, and the top wall that defines the distal end of the panel, wherein the panel further comprises a plurality of seams formed along the panel, wherein a first panel seam is formed between the floor and the first upstanding end wall, a second panel seam is formed between the first upstanding end wall and the top wall, and a third panel seam is formed at the juncture of the top wall mutually joined to the second upstanding end wall.

### V. BRIEF DESCRIPTION OF THE DRAWING(S)

The advantages and features of the invention and the respective embodiments will become better understood with reference to the following more detailed description and claims taken in conjunction with the accompanying drawings, in which like elements are identified with like symbols, and in which:

FIG. 1 is a perspective view of a rollably collapsible pet carrier;

FIG. 2 is an exploded perspective view of the rollably collapsible pet carrier;

FIG. 3 is an alternative embodiment in an exploded perspective view of the rollably collapsible pet carrier;

FIG. 4 is a side-view of the pet carrier depicting one of the upstanding sidewalls;

FIG. 5 is a top-view of the pet carrier;

FIG. 6 is a side-view of the pet carrier in a rolled and collapsible condition; and

FIG. 7 is a perspective view of the pet carrier in a rolled and collapsible condition and stowed in a portable carrying case.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

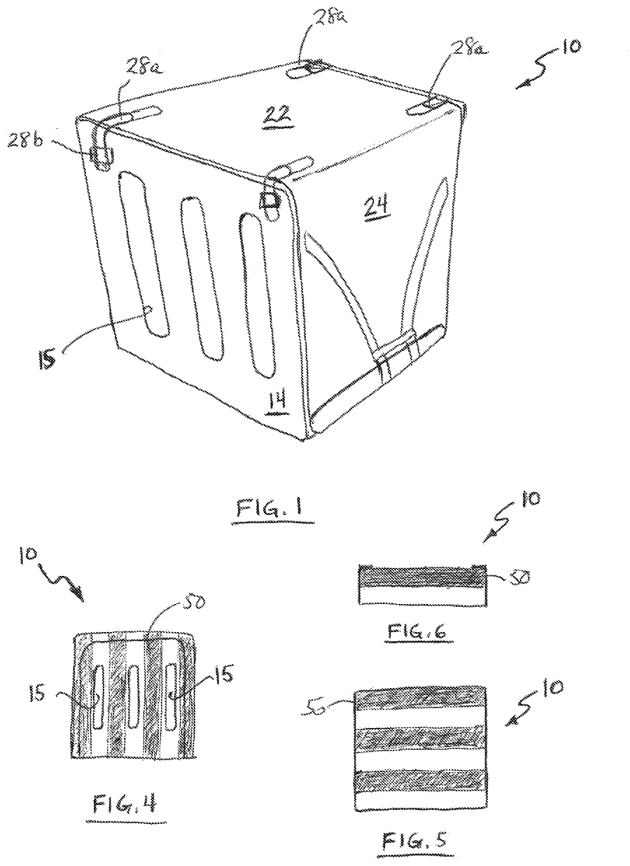

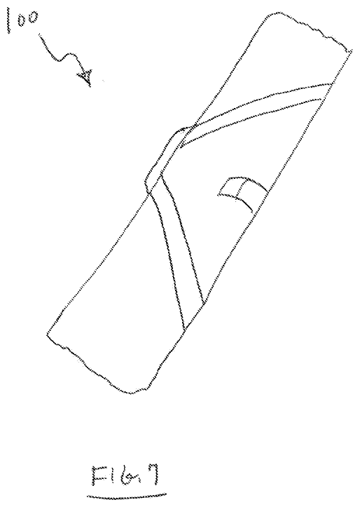

Consistent with the illustrations FIGS. 1 through 7, included herewith, a rolled and collapsible pet carrier 10 is described and disclosed. Consistent with FIGS. 1 through 3, the pet carrier 10 comprises an elongated panel 12 mutually coupled with a first upstanding sidewall 14 and a second upstanding sidewall 16. The panel 12 includes a floor 18 forming the base or bottom of the pet carrier, wherein the first upstanding sidewall 14 is mutually coupled with the floor 18 and the second upstanding sidewall 16 is mutually coupled with the floor 18, with the sidewalls 14 and 16 in mutual opposition and each separately depending from the floor 18 along opposing lower side margins of the floor 18.

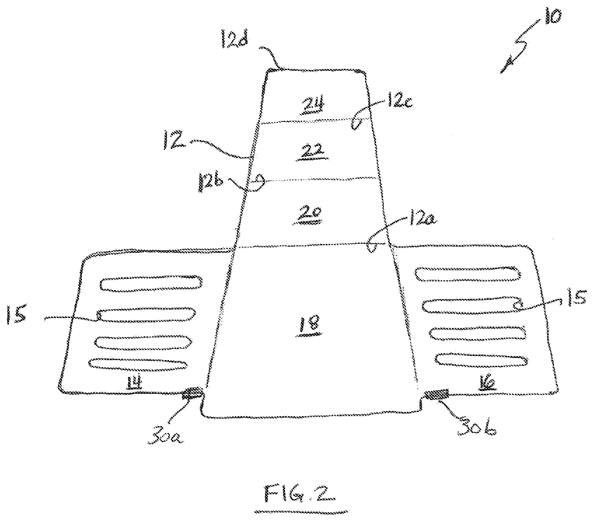

In one embodiment, consistent with FIG. 2, the panel 12 comprises a floor 18 at a proximal end (relative to the sidewalls 14 and 16) and includes a first upstanding end wall 20, a top wall 22, and a second upstanding end wall 24, with the second upstanding end wall 24 that defines the distal end (relative to the sidewalls 14 and 16) of the panel 12. The floor 18, end wall 20, top wall 22, and end wall 24 may be folded along panel seams or margins 12a-12c to form this portion of the enclosure and interior compartment of the pet carrier 10, wherein the end wall 24 is mutually joined or coupled with the floor 18.

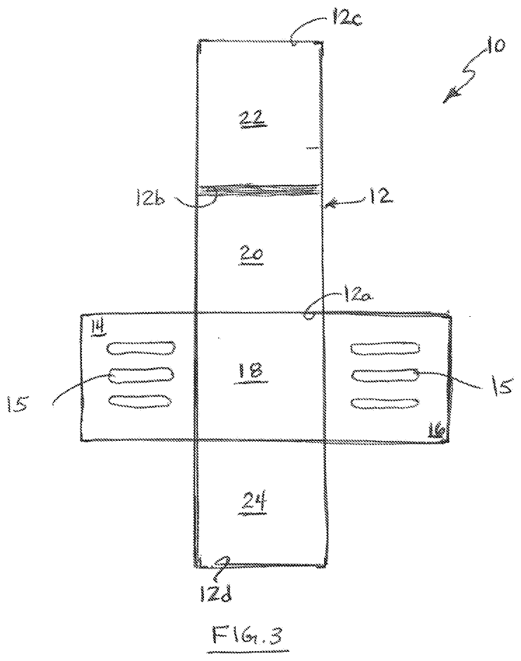

In another embodiment, consistent with FIG. 3, the panel 12 comprises a second upstanding end wall 24 at the proximal end (adjacent to the sidewalls 14 and 16) and includes a floor 18, the first upstanding end wall 20, and the top wall 22 that defines the distal end (relative to the sidewalls 14 and 16) of the panel 12. The floor 18, end wall 20, top wall 22, and end wall 24 may be folded along margins 12a-12c to form this portion of the enclosure and interior compartment of the pet carrier 10, wherein the top wall 22 is mutually joined or coupled with the end wall 24.

Consistent with the embodiment depicted in FIG. 2, the elongated panel 12 comprises a first panel seam 12a, a second panel seam 12b, a third panel seam 12c, and a fourth panel seam 12d. Folding the panel 12 at the first panel seam 12a defines and separates a floor 18 from a first upstanding end wall 20. Folding the panel 12 at the second panel seam 12b defines and separates the first upstanding end wall 20 from a top wall 22. Folding the panel 12 at the third panel seam 12c defines and separates the top wall 22 from the second upstanding end wall 24. The fourth panel seam 12d is the terminus of the panel 12 and mutually couples with an end margin of the floor 18 to form the enclosure and the interior compartment of the pet carrier 10.

Consistent with the embodiment depicted in FIG. 3, the elongated panel 12 comprises a first panel seam 12a, a second panel seam 12b, a third panel seam 12c, and a fourth panel seam 12d. Folding the panel 12 at the first panel seam 12a defines and separates a floor 18 from a first upstanding end wall 20. Folding the panel 12 at the second panel seam 12b defines and separates the first upstanding end wall 20 from a top wall 22. Coupling or joining the third panel seam 12c (at the distal terminus of top wall 22) with the fourth panel seam 12d (at the terminus of end wall 24) forms the enclosure and the interior compartment of the pet carrier 10.

Completing the formation of the enclosure and interior compartment of the pet carrier 10 includes the mutual coupling of the margins of the sidewalls 14, 16 to adjacent margins of the end walls 20 and 24 and the top wall 22. Mutual coupling of the margins of the sidewalls 14, 16 and end walls 20, 24 and top wall 22 may be accomplished by a variety of means.

For example, as best exemplified in FIG. 1, it is envisioned that a hook and loop material integrated with straps and buckles may be utilized for mutually coupling the sidewalls 14, 16 to the adjacent top side margins of end walls 20 and 24 and the top wall 22. In one variation, a plurality of straps 28a comprising hook and look material is fixed or attached along the end walls 20 and 24 and top wall 22, wherein each strap 28a is inserted through a buckle 28b fixed or attached along sidewalls 14 and 16. It is envisioned that the buckle(s) 28b may additionally include mechanical means for impinging or securing the strap(s) 28a therein and inhibit separation of the hook and loop material or otherwise inhibit undesirable movement of the strap(s) 28a once positioned to secure the walls 20, 24, top wall 22, and sidewalls 14, 16 in a fixed, cube-like orientation so as to form the enclosure/compartment of the carrier 10. In another variation, the plurality of straps 28a comprising hook and loop material is fixed or attached along the sidewalls 14 and 16, wherein each strap 28a is inserted through a buckle 28b fixed or attached along the end walls 20 and 24, and top 2 all 22. Similar to the description above, the buckle(s) 28b may additionally include mechanical means for impinging or securing the strap(s) 28a.

In another example, generally consistent with the illustration of FIG. 2, it is envisioned that a plurality of mechanical couplers may be utilized, such as one or more zippers. In such an embodiment, a first zipper 30a may be disposed for mutually coupling the first upstanding sidewall 14 with adjacent margins of the first upstanding end wall 20, the top wall 22, and the second upstanding end wall 24, and a second zipper 30b may be disposed for mutually coupling the second upstanding sidewall 16 with adjacent margins of the first upstanding end wall 20, the top wall 22, and the second upstanding end wall 24. First zipper 30a and second zipper 30b are depicted as the slider set upon the chain/teeth track of a zipper assembly.

For such embodiments, the unattached (free) margins of the sidewalls 14, 16 include one-half of the chain/teeth of the zipper assembly and the unattached (free) margins of the end walls 20, 24 and the top wall 22 include the remaining mateable one-half of the chain/teeth. The zipper assembly slider may be affixed to either chain along either unattached (free) margin(s) provided the slider body opening or window can receive and retain the pin of the chain/teeth tape provided thereon. Preferably, the orientation or disposition of the zippers 30a, 30b are such that mutual coupling is achieved by moving or urging the slider body from a rearward starting position to a forward starting position to facilitate ease of use in forming the enclosure and interior compartment therein. It is further envisioned, to provide additional security and structural integrity to the completed enclosure and interior compartment formation that the sidewalls 14, 16 and/or the floor 18 or top wall 22 include means for securing the slider pull tab to prevent inadvertent decoupling of the slider body from the chain/teeth and weakening the enclosure/compartment previously formed.

In another embodiment, each upstanding sidewall 14 and 16 comprises a plurality of windows or vents 15 for circulation and ventilation of air through the enclosure and interior compartment formed within the pet carrier 10 as defined by the sidewalls 14, 16, the end walls 20 and 24, and the floor 18 and top wall 22. In yet another alternative embodiment, a plurality of windows or vents 15 may be included in one or more of the end wall(s) 20 and/or 24, and/or top wall 22, or any combination or sub-combination thereof.

The panel 12 (and elements comprising end walls 20, 24, and the floor 18 and top wall 22) and the sidewalls 14, 16 may comprise a variety of materials. It is envisioned that the material, or combination of multiple materials, used for the panel 12 and the sidewalls 14, 16 provide(s) a surface that is durable and resilient, including characteristics and/or properties such as easily cleaned, waterproof, scratch-resistant, mold-resistant, fade-resistant with UV ray protectants, and further including padding for easy transportation and a reduction of potential damage caused by the portability of the carrier 10. This may include materials such as canvas, polyester, vinyl, nylon, and/or combinations thereof. As but one non-exhaustive example of the type of commercially-available material that could be used or utilized as an element of the fabric forming the panel 12 and the sidewalls 14,16, the material OTTERTEX® and/or its commercially-available equivalents might be incorporated therewith.

The material comprising the panel 12 (all of its elements) and the sidewalls 14, 16 is additionally supported by an underlying skeleton. The skeleton comprises substrate or slat members enveloped by the material utilized as a protective covering for the skeleton, wherein the substrate and/or slat members comprises a rigid material, such as plastic, polymer, or a combination thereof. For example, and as best understood relative to FIGS. 4 through 6, polypropylene plastic has demonstrated effectiveness for this type of use and is generally disposed in the dark-shaded areas or regions defined in FIGS. 4 through 6. In the floor 18 of the panel 12, the substrate/slat members are contiguous and disposed within pockets formed within the material used. For the sidewalls 14, 16, end walls 20, 24, and top wall 22, the substrate/slat members are alternating in defined increments.

In one exemplary embodiment, though not exhaustive of other alternatives, the substrate/slat members are approximately 1.5 inches in width and are positioned or disposed within 2-inch pockets formed in the material, with the substrate/slat members disposed or positioned in an alternating and/or discontinuous arrangement.

Consistent with FIG. 7, the pet carrier 10 is rolled into a collapsible manner for stowing or storage and transport via a carrying case or bag 100. The case or bag 100 may include closures and straps for ease of transporting the pet carrier 10 once broken-down for storage. It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A pet carrier comprises:
an elongated panel mutually coupled with a first upstanding sidewall and a second upstanding sidewall, each of the upstanding sidewalls comprising a plurality of vents; and
the elongated panel comprising a plurality of walls defining the center covering of the pet carrier, the elongated panel foldable for forming the center covering of the pet carrier.

2. A pet carrier comprises:
an elongated panel mutually coupled with a first upstanding sidewall and a second upstanding sidewall;
the elongated panel comprising a floor, wherein the first upstanding sidewall is mutually coupled with the floor along a first lower side margin, and wherein the second upstanding sidewall is mutually coupled with the floor along a second lower side margin, the first lower side margin and second lower side margin in mutual opposition, and the first upstanding sidewall and the second upstanding sidewall in mutual opposition; and
the elongated panel comprising a plurality of walls defining the center covering of the pet carrier, the elongated panel comprising at least the first end wall and the top wall.

3. The pet carrier of claim 2, wherein the elongated panel comprises:
a proximal end adjacent the first upstanding sidewall and the second upstanding sidewall and an opposing distal end;
the proximal end including the floor and a first upstanding end wall depending from the floor, a top wall depending from the first upstanding end wall, and a second upstanding end wall depending from the top wall, with the second upstanding end wall defining the distal end of the panel.

4. The pet carrier of claim 3 further comprising a plurality of seams formed along the panel, wherein a first panel seam is formed between the floor and the first upstanding end wall, a second panel seam is formed between the first upstanding end wall and the top wall, a third panel seam is formed between the top wall and the second upstanding end wall, and a fourth panel seam is formed at the juncture between the second upstanding end wall and the floor.

5. The pet carrier of claim 4, wherein folding the panel along the first panel seam, the second panel seam, the third panel seam, and mutually joining the second upstanding end wall and floor to form the fourth panel seam form an enclosure.

6. The pet carrier of claim 5, wherein the enclosure is temporarily formed by the mutual coupling of the top side margin of the first upstanding sidewall to the side margins of the first upstanding end wall, the top wall, and the second upstanding end wall and by the mutual coupling of the top side margins of the second upstanding sidewall to the side margins of the first upstanding end wall, the top wall, and the second upstanding end wall.

7. The pet carrier of claim 6, wherein a plurality of straps and buckles are used to mutually couple the sidewalls to the end walls and top walls, the plurality of straps comprising hook and loop material.

8. The pet carrier of claim 6, wherein a plurality of zipper assemblies are used to mutually couple the sidewalls to the end walls and top walls.

9. The pet carrier of claim 2, wherein the elongated panel comprises:
a proximal end adjacent the first upstanding sidewall and the second upstanding sidewall and an opposing distal end;
a second upstanding end wall at the proximal end comprising the floor, the first upstanding end wall, and the top wall that defines the distal end of the panel.

10. The pet carrier of claim 9 further comprising a plurality of seams formed along the panel, wherein a first panel seam is formed between the floor and the first upstanding end wall, a second panel seam is formed between the first upstanding end wall and the top wall, and a third panel seam is formed at the juncture of the top wall mutually joined to the second upstanding end wall.

11. The pet carrier of claim 10, wherein folding the panel along the first panel seam, the second panel seam, and mutually joining the second upstanding end wall and the top wall to form the third panel seam form an enclosure.

12. The pet carrier of claim 11, wherein the enclosure is temporarily formed by the mutual coupling of the top side margin of the first upstanding sidewall to the side margins of the first upstanding end wall, the top wall, and the second upstanding end wall and by the mutual coupling of the top side margins of the second upstanding sidewall to the side margins of the first upstanding end wall, the top wall, and the second upstanding end wall.

13. The pet carrier of claim 12, wherein a plurality of straps and buckles are used to mutually couple the sidewalls to the end walls and top walls, the plurality of straps comprising hook and loop material.

14. The pet carrier of claim 12, wherein a plurality of zipper assemblies are used to mutually couple the sidewalls to the end walls and top walls.

15. The pet carrier of claim 2, wherein the panel comprises a durable and resilient material.

16. The pet carrier of claim 15, wherein the panel comprises a skeleton having substrate members enveloped by the panel and the material utilized as a protective covering for the skeleton, wherein the substrate and/or slat members comprises a rigid material.

17. A pet carrier comprises:
a storage bag;
an elongated panel mutually coupled with a first upstanding sidewall and a second upstanding sidewall;
the elongated panel comprising a floor, wherein the first upstanding sidewall is mutually coupled with the floor along a first lower side margin, and wherein the second upstanding sidewall is mutually coupled with the floor along a second lower side margin, the first lower side margin and second lower side margin in mutual opposition, and the first upstanding sidewall and the second upstanding sidewall in mutual opposition;
the elongated panel comprising a plurality of walls defining the center covering of the pet carrier, the elongated panel comprising at least the first end wall and the top wall;
the elongated panel foldable and compressible and forming a rolled apparatus storable within the storage bag.

18. The pet carrier of claim 17, wherein the panel comprises a proximal end adjacent the first upstanding sidewall and the second upstanding sidewall and an opposing distal end, wherein the proximal end including the floor and a first upstanding end wall depending from the floor, a top wall depending from the first upstanding end wall, and a second upstanding end wall depending from the top wall, with the second upstanding end wall defining the distal end of the panel, wherein the panel further comprises a plurality of seams formed along the panel, wherein a first panel seam is formed between the floor and the first upstanding end wall, a second panel seam is formed between the first upstanding end wall and the top wall, a third panel seam is formed between the top wall and the second upstanding end wall, and a fourth panel seam is formed at the juncture between the second upstanding end wall and the floor.

19. The pet carrier of claim 17, wherein the panel comprises a proximal end adjacent the first upstanding sidewall and the second upstanding sidewall and an opposing distal end, the panel comprising a second upstanding end wall at the proximal end comprising the floor, the first upstanding end wall, and the top wall that defines the distal end of the panel, wherein the panel further comprises a plurality of seams formed along the panel, wherein a first panel seam is formed between the floor and the first upstanding end wall, a second panel seam is formed between the first upstanding end wall and the top wall, and a third panel seam is formed at the juncture of the top wall mutually joined to the second upstanding end wall.
